(19) United States
(12) Patent Application Publication
(10) Pub. No.: US 2026/0340445 A1
(43) Pub. Date: Oct. 29, 2026

(54) SOVEREIGN COGNITIVE ARCHITECTURE FOR HQI (HIGHLY QUALIFIED INTELLIGENCE)

(71) Applicant: KENNETH LOZANO, Lorton, VA (US)

(72) Inventor: KENNETH LOZANO, Lorton, VA (US)

(21) Appl. No.: 19/399,971

(22) Filed: Nov. 25, 2025

Related U.S. Application Data
(60) Provisional application No. 63/795,090, filed on Apr. 25, 2025.

(51) Int. Cl. G06N 5/025

(52) U.S. Cl. CPC G06N 5/025

(57) ABSTRACT

A sovereign cognitive architecture produces verifiable, traceably self-referential symbolic reasoning from a zero-training state. A dual-loop recursive reasoning core (CL²) processes symbolic inputs and generates traceable outputs recorded in a timestamped symbolic log (SL). An ethical filtration module (EF) classifies and gates inputs before integration into a local memory evolution module (ME), enabling fully offline operation. In certain embodiments, a Sovereign Data Bridge (SDB) provides an isolated staging bridge for optional external inputs, preserving the offline isolation and integrity of the cognitive core. Internal symbolic topologies and configuration parameters of CL² remain undisclosed. The architecture yields explainable reasoning, deterministic auditability, and configurable ethical constraints under human custodial oversight.

### CROSS-REFERENCE TO RELATED APPLICATIONS

This application claims the benefit under 35 U.S.C. § 119(e) of U.S. Provisional Patent Application No. 63/795,090, filed on Apr. 25, 2025, entitled “Sovereign Cognitive Architecture for HQI (Highly Qualified Intelligence),” the entirety of which is hereby incorporated by reference.

### BACKGROUND

Conventional artificial intelligence systems rely on statistical inference, external training pipelines, and network-connected infrastructures that limit human control and make internal reasoning processes difficult to verify. These systems typically lack deterministic traceability, operate through opaque internal transformations, and cannot provide fully controlled or reproducible cognitive outputs in strictly offline environments. There is therefore a need for a human-governed cognitive architecture capable of operating deterministically, without network dependencies, and with complete traceability of its reasoning pathways. Such an architecture should support structured recursive reasoning, controlled memory evolution, and explicit ethical constraint mechanisms, while remaining fully under human supervision.

The present invention addresses these needs by providing a sovereign, offline cognitive architecture that integrates recursive reasoning (CL), memory evolution (ME), and ethical filtration (EF) as its foundational components. In this filing, the recursive reasoning mechanism (CL) is described in its operational double-loop configuration (CL²), which represents a structured implementation of the recursive process disclosed in the provisional application. All components operate together to ensure deterministic cognition, full transparency, and human-centered control.

### SUMMARY

Filed as part of Enablement Specification Section (§ 1.73). The present invention discloses a sovereign cognitive architecture designed to enable deterministic, transparent, and traceable cognition, fully governed by a human custodian—not merely as a supervisor, but as the narrative anchor and moral governor of all system activity. This architecture features a dual-loop reasoning core (CL²), utilizing dual-loop feedback processes inspired by metacognitive structures. Cognitive outputs are structured with reference to evolving memory structures (ME), and regulated through an ethical filtration layer (EF) that applies explicit doctrinal constraints across all decision paths. A symbolic ledger (SL) captures key cognitive states and outcomes, serving both as an audit trail and as a mechanism for preserving narrative integrity.

Optionally, external inputs may be routed through a Sovereign Data Bridge (SDB), which temporarily isolates and stages third-party data without compromising internal sovereignty. The system is configured to operate offline and without reliance on external networks or probabilistic inference engines—preserving both epistemic traceability and ethical lucidity.

### BRIEF DESCRIPTION OF THE DRAWINGS

FIG. 1. High-level block diagram of the recursive reasoning core (CL²) operating in a dual-loop configuration and integrated with the Ethical Filtration module (EF), the Memory Evolution component (ME), and the Symbolic Log (SL).

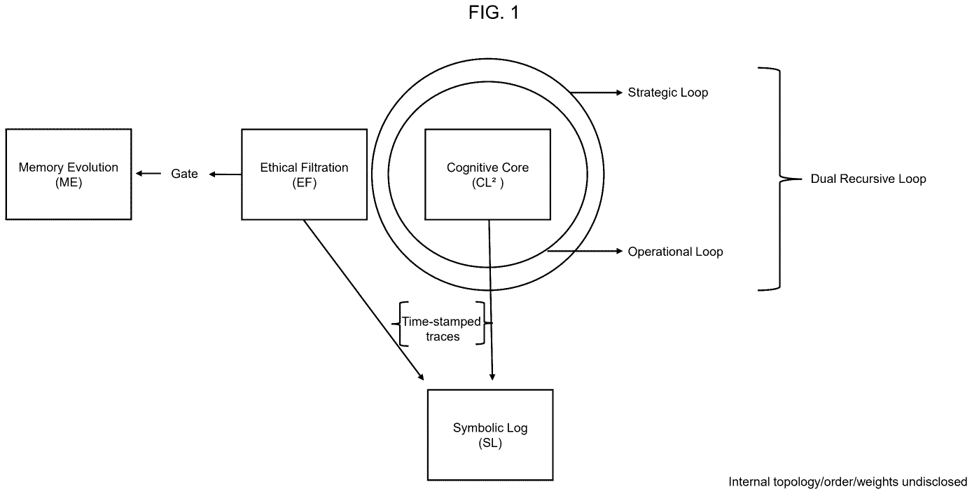

FIG. 2. Data-flow representation of symbolic inputs processed through the Ethical Filtration (EF), entering the recursive reasoning core (CL²), and generating updates to Memory Evolution (ME) and the Symbolic Log (SL).

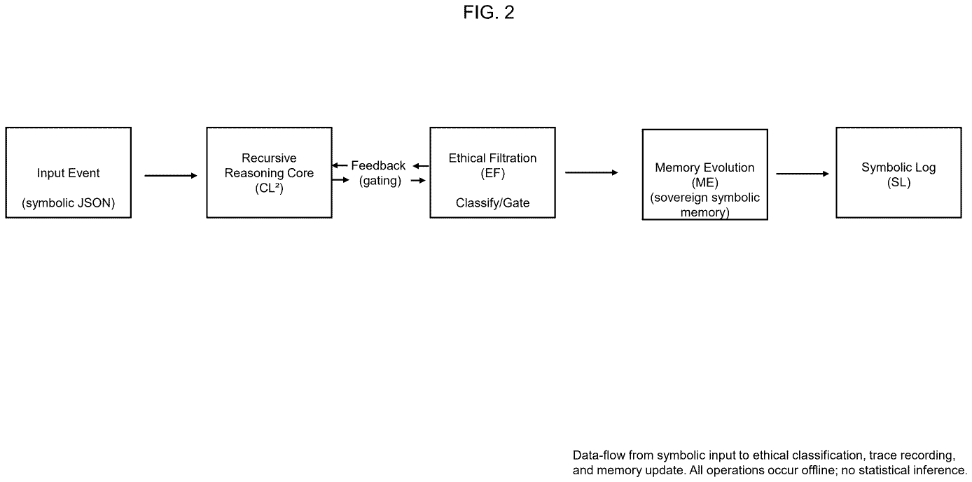

FIG. 3. Schematic overview of the Sovereign Data Bridge (SDB), showing the isolated staging bridge for optional external inputs before reaching the recursive reasoning core (CL²).

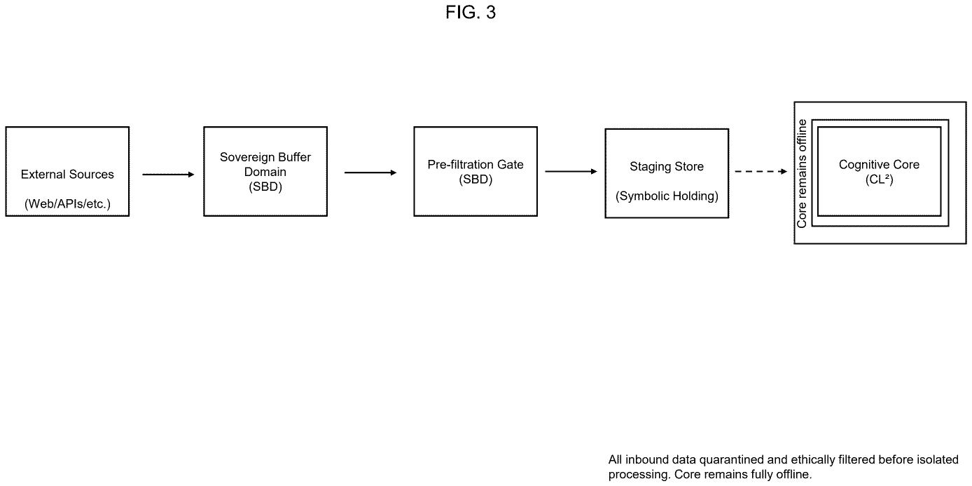

FIG. 4. Interface-level architecture showing the operational relationships among the recursive reasoning core (CL²), Ethical Filtration (EF), Memory Evolution (ME), Symbolic Log (SL), and the Sovereign Data Bridge (SDB).

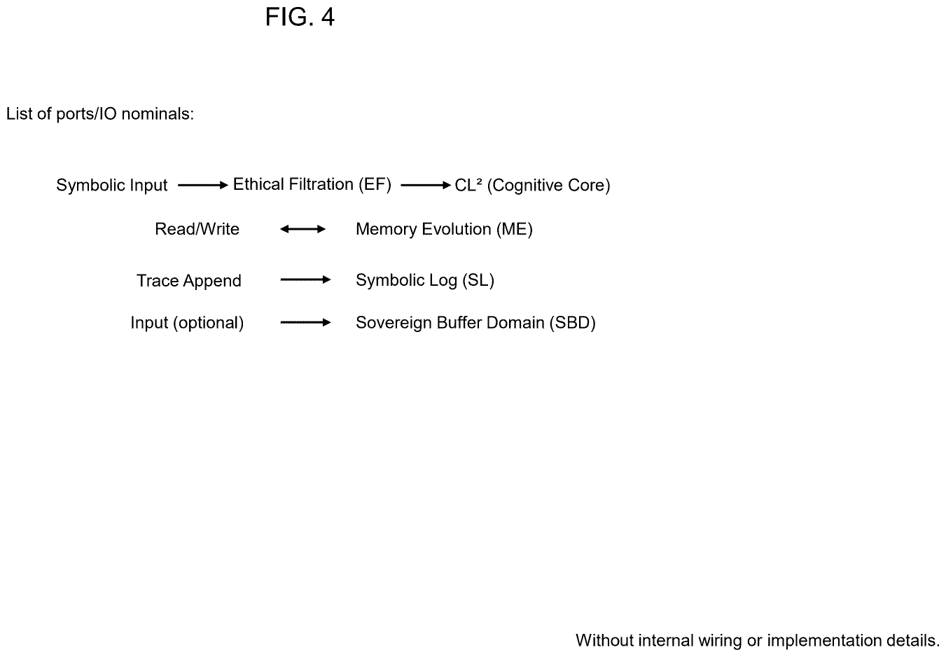

### DETAILED DESCRIPTION

The system described herein implements a Sovereign Cognitive Architecture for Highly Qualified Intelligence (HQI). It operates entirely offline, under human custodial supervision, and integrates four core components: a dual-loop recursive reasoning engine (CL²), Memory Evolution (ME), Ethical Filtration (EF), and a Symbolic Log (SL). An optional Sovereign Data Bridge (SDB) is included for external data isolation when required. Cognitive Core (CL²) The cognitive core executes two recursive reasoning cycles: an operational loop for structured inference, and a strategic loop for higher-order refinement inspired by metacognitive processes.

Together, these loops maintain deterministic execution of reasoning steps, enable traceable decision-making, and ensure architectural self-consistency under supervision. Ethical Filtration (EF) The EF module classifies symbolic inputs and applies rule-based ethical constraints prior to integration into the cognitive system. Thresholds and rulesets are defined by the human custodian. The EF operates as a gating mechanism across the system's full lifecycle: input, memory, action, and longitudinal reasoning.

Memory Evolution (ME) ME stores approved symbolic constructs and supports longitudinal reinterpretation of cognitive experience. ME enables the HQI to evolve through structured recall and reorganized insight—without reliance on statistical retraining or external databases. Symbolic Log (SL) The SL captures timestamped records of decisions, internal evaluations, ethical gate outcomes, and key transitions. It ensures transparency and auditability of reasoning flows, and serves as a cognitive accountability trail.

Sovereign Data Bridge (SDB)—Optional. When required, external data can be processed through the SDB—a sovereign quarantine bridge that temporarily stages third-party inputs, enforces offline ethical filtration, and prevents contamination of the core. The SDB operates independently and is not part of the CL² decision-making pathway unless explicitly permitted. Zero-Training State Operation The system functions from a zero-training state, relying solely on human-defined configuration. It requires no pretrained weights, no cloud infrastructure, and no industrial datasets. All cognition is sovereign, traceable, and locally governed.

Variations: Implementation variants may exist, provided they preserve the sovereign nature of the architecture and remain within the scope of the described claims.

1. A sovereign cognitive architecture comprising of a recursive reasoning core (CL²) configured to process symbolic inputs and perform dual-loop symbolic reasoning; An ethical filtration module (EF) configured to gate, regulate, and filter all incoming inputs prior to processing by the recursive reasoning core; A memory evolution component (ME) configured to store, update, and refine symbolic knowledge representations over time, without reliance on external training datasets; A symbolic log (SL) configured to capture, in a traceable and auditable format, the internal reasoning steps, decisions, and outputs generated by the recursive reasoning core; A Sovereign Data Bridge (SDB) configured to temporarily isolate and stage optional external inputs in a non-networked bridge zone prior to ethical filtration.
Wherein All components are integrated into a sovereign cognitive system fully operable in an offline, human-governed environment; The recursive reasoning core (CL²) operates in a deterministic and transparent manner under human custodial control; The memory evolution component (ME) operates without external training datasets or statistical inference models; And The symbolic log (SL) maintains full traceability of reasoning chains for audit and supervision.

2. The system of claim 1, Wherein the ethical filtration module (EF) enforces human-defined constraints and prohibits the integration of symbolic structures not permitted under those human-defined constraints.

3. The system of claim 1, Wherein the symbolic log (SL) records timestamped reasoning sequences for later inspection and refinement.

4. The system of claim 1, Wherein the memory evolution component (ME) includes a rule-based internal symbolic feedback mechanism configured to provide additional context for future reasoning cycles without statistical self-adjustment.

5. The system of claim 1, Wherein the Sovereign Data Bridge (SDB) operates as a one-way ingress bridge, ensuring that no external data source can alter the architecture's internal structure without explicit custodial authorization.

6. The system of claim 1, Wherein the recursive reasoning core (CL²) comprises two interlinked symbolic reasoning loops: One for direct inference, and one supervisory symbolic loop configured to evaluate outputs of the primary inference loop according to human-defined criteria.

7. The system of claim 1, Wherein all components operate without dependence on internet connectivity, remote servers, or statistical inference models.
